(19) United States
(12) Patent Application Publication
(10) Pub. No.: US 2017/0351826 A1
(43) Pub. Date: Dec. 7, 2017

(54) MedMobile device

(71) Applicants: James Edward Mclean, JR., Charlotte, NC (US); Edward D. Mclean, San Marcos, TX (US)

(72) Inventors: James Edward Mclean, JR., Charlotte, NC (US); Edward D. Mclean, San Marcos, TX (US)

(73) Assignee: Mcleanics Technology Corporation

(21) Appl. No.: 14/999,626

(22) Filed: Jun. 7, 2016

(51) Int. Cl. G06F 19/00; H04B 1/3827; H04L 29/08; H04M 1/725

(52) U.S. Cl. CPC G06F 19/3418; H04M 1/72538; G06F 19/327; H04B 1/3833; H04L 67/12

(57) ABSTRACT

The MedMobile Device (MMD), is a medical device or circuit, software, application or App, software program, or platform, that enables a smart phone, tablet, laptop, computer, or any other mobile computer device, to take mobilized blood pressure readings, temperature readings, pulse readings, heart readings (EKG/ECG), and other vital sign readings, of a patient located outside of a heath care facility; and to monitor, track, store, process, the patient's data or information. This is accomplished by a special software App or program installed on a smart phone, tablet, computer, or any other mobile computer device, network, or platform. This software App or program communicates with the MMD, and the MMD simultaneously communicates with a special attached sensing device or sensor by sending and receiving data to and from the attached sensing device or sensor; this data may represent the blood pressure, temperature, pulse, heart rate, or other vital sign readings of the patient. The sensing device or sensor is attached to the MMD by use of a USB port, or other types of connector means, or may be interfaced by wireless means, such as, Blue Tooth, WiFi, or other wireless means or protocols. Further the MMD's platform enables a patients, health care providers or professionals, to interact, correspond, or communicate health care issues or concerns via the internet, and to use platform based applications to manage appointments, peer-to-peer social communication, etc.

### CROSS REFERENCE TO RELATED APPLICATION

This application is related to the MedMobile Device Provisional Patent Application, Application No. 62/284,571; filed on Oct. 5, 2015.

### STATEMENT REGARDING FEDERAL SPONSORED RESEARCH

None Applicable.

### REFERENCE TO SEQUENCE LISTING, TABLE, OR A COMPUTER PROGRAM LISTING COMPACT DISC APPENDIX

None Applicable.

### BACKGROUND OF INVENTION

The MedMobile Device (MMD), is in the field of Mobile Medical Equipment and Software. As of today, we have medical equipment and software that can read the vital signs of a patient in a hospital or other types of health care facilities. However, we have now advanced to a time when health care is being provided in the patient's home or some other place outside of the traditional hospital or health care facility, this type of health care service is in high demand. And, when it comes a time when “in home” health care patients need their vital sign readings done, a trip to the health care facility becomes unavoidable, or the health care service provider will have to hall around many large or bulky test equipment, the MMD solves this problem. The MMD enables a smart phone, tablet, laptop, computer, or any other mobile computer, to become several mobile medical devices in one; and to track, maintain, store, or transmit the patient's information or data to a platform, health care facility, network, or other types of computer, data processing or data storage systems. Further, the MMD's software and platform provides the medical professional, heath care provider, and patient with platform based applications to maintain, store, process and perform other tasks and functions with the patient, the patient's data, or any other needed health care services.

### BRIEF SUMMARY OF INVENTION

The MedMobile Device (MMD), is a medical device or circuit, software, application or App, software program, or platform, that enables a smart phone, tablet, laptop, computer, or any other mobile computer device, to take mobilized blood pressure readings, temperature readings, pulse readings, heart readings (EKG/ECG), and other vital sign readings, of a patient located outside of a heath care facility; and to monitor, track, store, process, the patient's data or information. Further, the MMD provides software applications that enables the patient and the health care provider or professional to remotely interact, correspond, and communicate medical issues or services without the need of a trip to the health care facility. And, the MMD's platform may provide the health care professional or provider with peer to peer Social Communications, Application Software, and other medical platform based programs or services, to effectively manage their medical practice. The MMD provides a mobile solution that enables the health care professional or provider to provide “in home” health care services without the need of unnecessary trips to the health care facility or the need to hall around large or bulky medical equipment.

### BRIEF DESCRIPTION OF THE SEVERAL VIEWS OF THE DRAWINGS

FIG. 1, is the 3D view of the Invention.

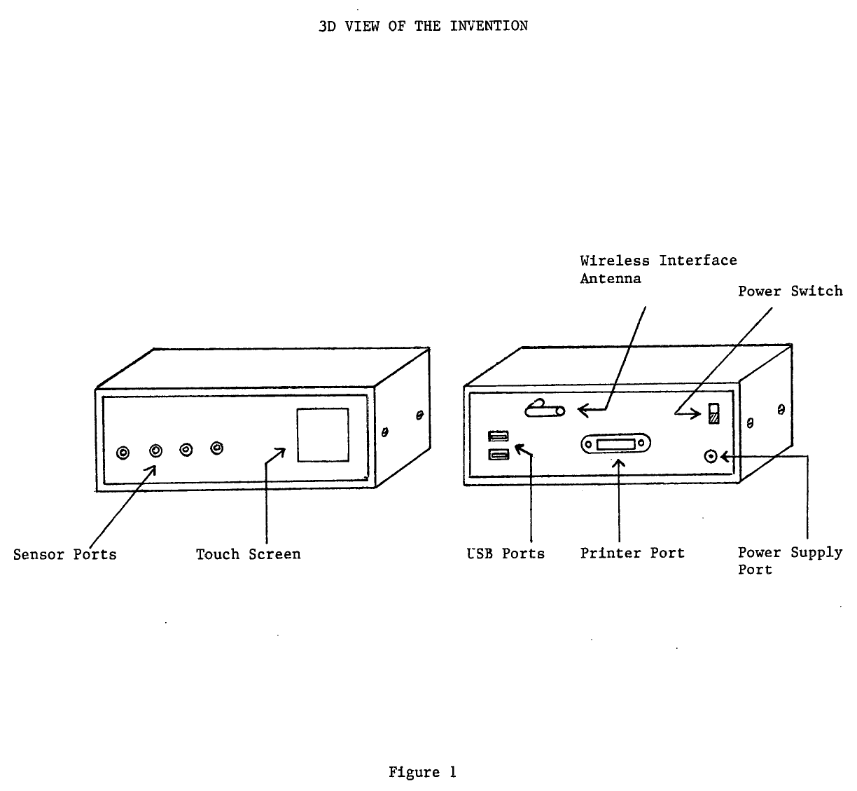

FIG. 2, is the Connectivity view of the Invention.

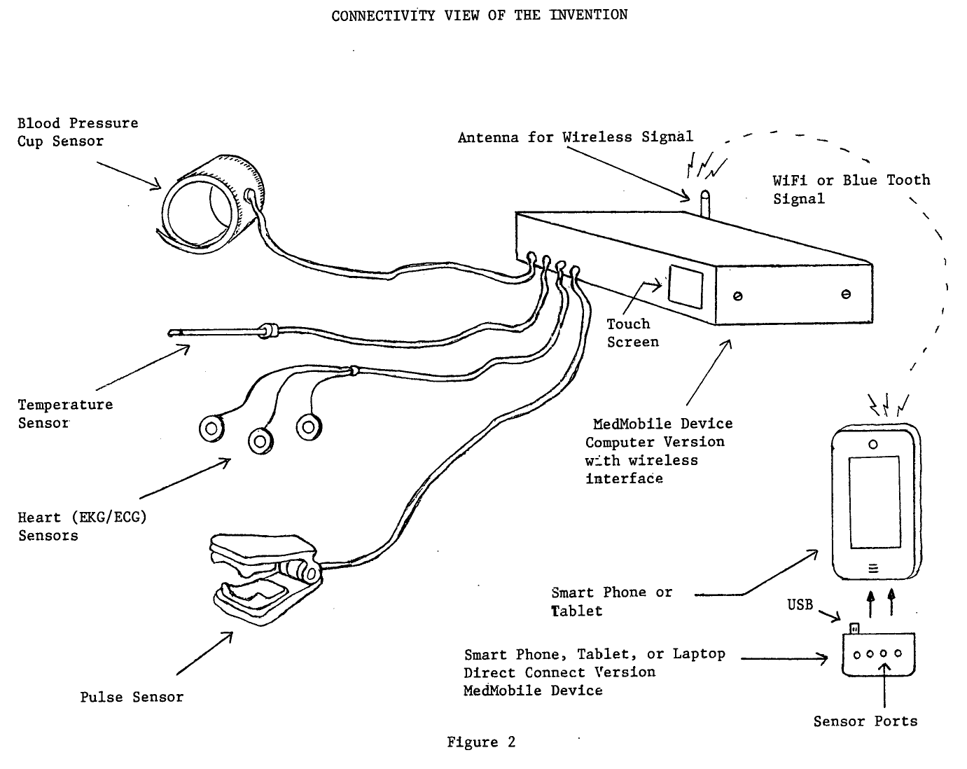

FIG. 3, is the Left and Right view of the Invention.

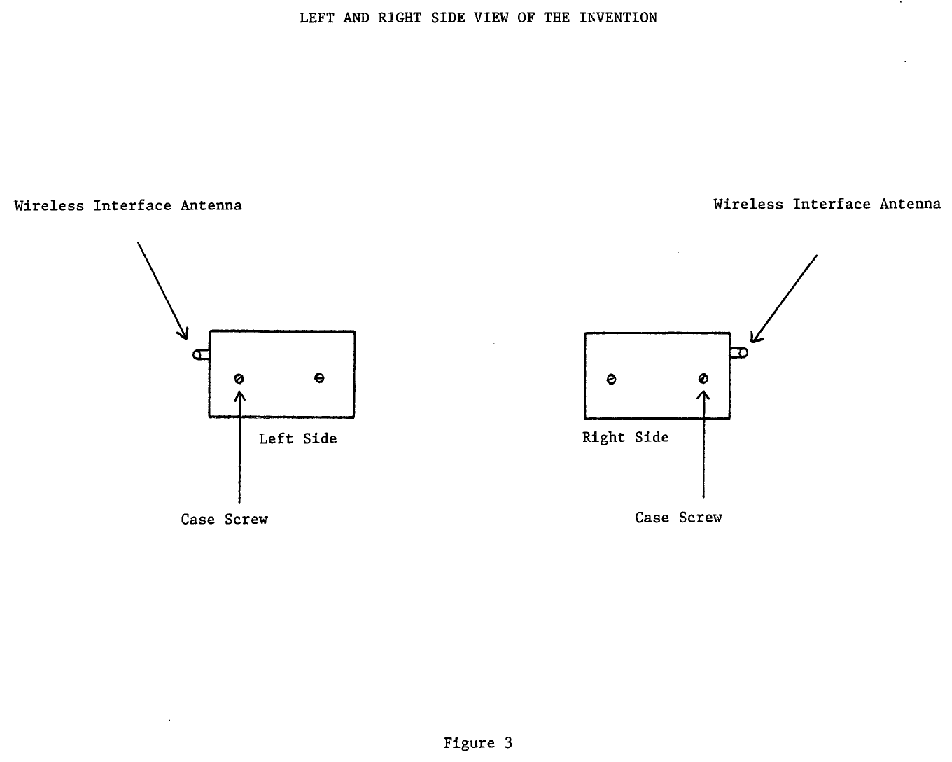

FIG. 4, is the Top and Bottom view of the Invention.

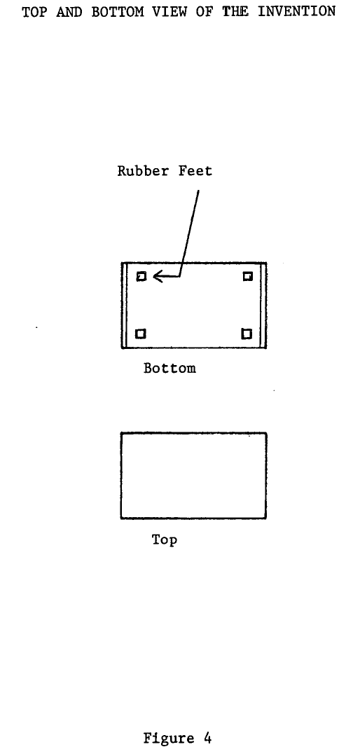

FIG. 5, is the Pictorial Wiring Diagram view of the Invention.

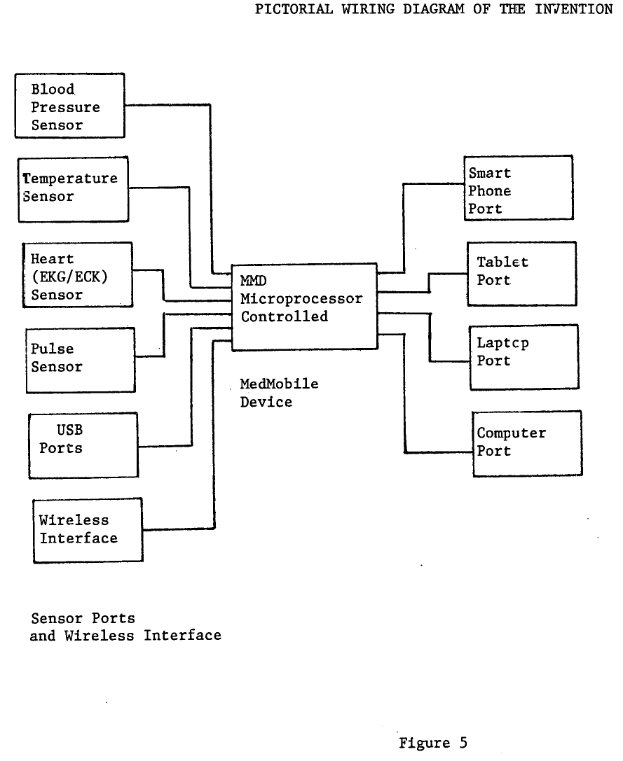

FIG. 6, is the Platform view of the Invention.

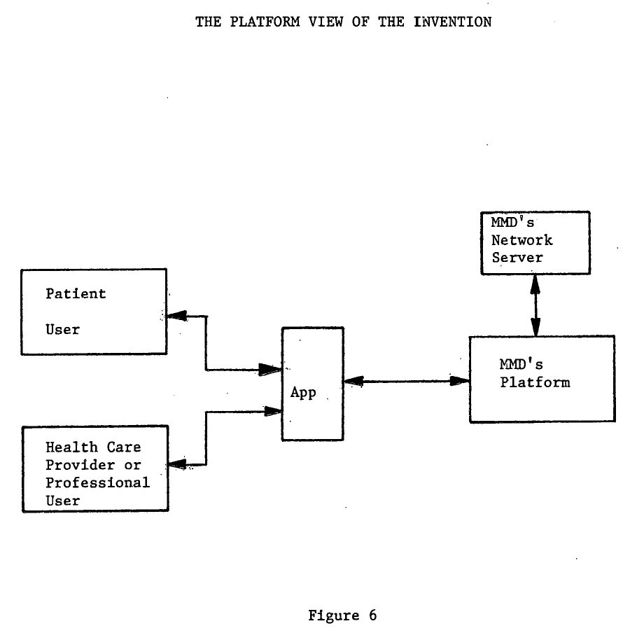

### DETAIL DESCRIPTION OF THE INVENTION

The MedMobile Device (MMD), is a medical device or circuit, software, application or App, software program, or platform, that enables a smart phone, tablet, laptop, computer, or any other mobile computer device, to take mobilized blood pressure readings, temperature readings, pulse readings, heart readings (EKG/ECG), and other vital sign readings, of a patient located outside of a heath care facility; and to monitor, track, store, process, the patient's data or information. This is accomplished by a special software App or program installed on a smart phone, tablet, computer, or any other mobile computer device, network, or platform. The software App or program communicates with the MMD, and the MMD simultaneously communicates with a special attached sensing device or sensor by sending and receiving data to and from the attached sensing device or sensor; this data may represent the blood pressure, temperature, pulse, heart rate, or other vital sign readings of the patient. The sensing device or sensor is attached to the MMD by use of a USB port, or other types of connector means, or may be interfaced by wireless means, such as, Blue Tooth, WiFi, or other wireless means or protocols.

The MMD attaches to a smart phone, tablet, laptop, computer, or any other mobile computer device, by inserting the MMD's USB connector into the USB port of the smart phone, tablet, laptop, computer, or any other mobile computer device, other connector types may be used as well; or the MMD may be attached by way of a wireless means, such as, Blue Tooth, WiFi, etc.

The special sensing devices or sensors attaches directly to the MMD via USB port, or may be interfaced by wireless means, such as, Blue Tooth, WiFi, or other types of wireless means or protocols. And the special sensing devices or sensors send vital sign readings or data to the MMD for processing, storage, etc.

The MMD can store the temperature readings, pulse readings, blood pressure readings, and heart readings (ECG/EKG), in a secured file on the smart phone, tablet, laptop, computer, or any other mobile computer devices; or the data can be securely transmitted back to the health care facility via the internet; or the data can be securely unloaded to the MMD's platform and securely stored on the MMD's network server for later use by the health care professional or health care provider, and/or the data can be printed.

The MMD's App or software program installed on a smart phone, tablet, computer, or any other mobile computer device, will enable the patient to communicate with the MMD's platform network via the internet. The patient will be able to schedule or reschedule appointments with their health care provider, renew prescriptions, report any health care issues or concerns, or communicate any other health care issues or concerns, or simply socially correspond with their health care providers or professionals. And, the patient may send or trigger an emergency or distress alert to summon medical help or authorities. If the patient so elects, the patient may access the MMD's platform directly via its web site address.

The MMD's App or software program, installed on a smart phone, tablet, computer, or any other mobile computer device, will enable the health care provider or professional to access the MMD's platform network via the internet. The health care provider or professional will be able to address the patient's health care issues or concerns, or respond to any of the patient's social communications, renew prescriptions, schedule appointments, reschedule appointments, or manage appointments, view and manage the patient's vital sign readings or data, etc. Alerts of the appointments will be sent to the patient and health care provider or professional, once the appointments are scheduled on the MMD's platform, software program, or App.

The MMD's platform provides the health care provider or professional with web based software applications that enables the health care provider or professional to effectively and efficiently manage their medical practice and to interact with the patient remotely and without the need of a face-to-face visit in a health care facility.

Further, the MMD's platform will enable the health care provider or professional to socially communicate or correspond with other health care providers or professionals (peer-to-peer communications), and to use other web based programs and applications on the MMD's platform, and to link to other social sites or platforms without exiting the MMD's platform.

The MMD can be a circuit that is incorporated or embedded within the circuitry of a smart phone, tablet, computer, or any other mobile computer device; therefore, enabling these devices to take vital sign readings of a patient, store said vital sign readings, or securely transmit said vital sign readings via the internet. Said circuit will also permit a smart phone, tablet, computer, or any other mobile computer device to access the MMD's platform via the internet.

1) A device or circuit that attaches to a mobile computer device, or is incorporated, embedded, or installed within a mobile computer device, and said device or circuit enables the mobile computer device to take vital sign readings of a patient, and/or transmit said vital sign readings via the internet, and/or enables a patient, health care provider or professional, to interact, correspond, or communicate health care issues or concerns via the internet.

2) The device, as outline in claim number 1, and said mobile computer is a smart phone, tablet, laptop, computer, or any other mobile computer.

3) The circuit, as outline in claim number 1, and said circuit is incorporated or embedded within the circuitry of a smart phone, tablet, laptop, computer, or any other mobile computer.

4) The device, as outline in claim number 1, and said device attaches to a smart phone, tablet, laptop, computer, or any other mobile computer, by a USB connector, or other connector types, or by a wireless means, such as, Blue Tooth, WiFi, or other wireless means or protocols.

5) The device, as outline in claim number 1, and said device is a software program or App, installed on a smart phone, tablet, laptop, computer, or any other mobile computer device.

6) The device, as outline in claim number 1, and said device is a software program, App, platform, or network, that enables the patients and health care providers or professionals to schedule or manage appointments, and send alert for said appointments to the patient and health care provider or professional via email, text, or other means.

7) The device, as outline in claim number 1, and said device is a software program, App, platform, or network, that enables the patients and health care providers or professionals to renew prescriptions via the internet.

8) The device, as outline in claim number 1, and said device is a software program, App, platform, or network, that enables the patients to report health care issues, concerns, or socially communicate or correspond with their health care providers or professionals via the internet.

9) The device, as outline in claim number 1, and said device is a software program, App, platform, or network, that enables the health care providers or professionals to socially communicate or correspond with other health care providers or professionals, via the internet, on a peer-to-peer bases.

10) The device, as outline in claim number 1, and said device is a software program, App, platform, or network, that enables the temperature readings, pulse readings, blood pressure readings, heart readings (EKG/ECG), or other vital sign readings, to be stored in a secured file on a smart phone, tablet, laptop, computer, or any other mobile computer devices, and/or said data can be securely transmitted back to the health care facility via the internet, or the data can be securely unloaded to said platform and securely stored on said platform's network server for later use by the health care professional or health care provider, and said data can be printed if so desired.

11) The device or circuit, as outlined in claim number 1, and said device or circuit has special sensing devices or sensors that are capable of attaching to said device or circuit via USB ports, or other types of connector means, or may be interfaced by a wireless means, such as, Blue Tooth, WiFi, or other wireless means or protocols, and said special sensing devices or sensors, senses the patient's vital signs, such as, but not limited to, blood pressure, pulse, heart rate (ECG/EKG), temperature, etc., and send said vital sign readings or data to said device or circuit for processing, storage, etc.

12) A software program or App, that communicates or controls the device or circuit, as outlined in claim number 1, and simultaneously communicates with the sensing devices or sensors that are attached to said device or circuit.

13) The device or circuit, as outlined in claim number 1, and said device or circuit enables the patient to send or trigger an emergency or distress alert to summon medical help or the authorities.
